(19) United States
(12) Patent Application Publication
(10) Pub. No.: US 2009/0202058 A1
(43) Pub. Date: Aug. 13, 2009

(54) TELEPHONIC AUTOMATED ACTION SYSTEM

(76) Inventor: Mamoon Tariq Khan, Islamabad (PK)

Correspondence Address: CLOCK TOWER LAW GROUP, 2 CLOCK TOWER PLACE, SUITE 255, MAYNARD, MA, 01754-2545, US

(21) Appl. No.: 12/366,079

(22) Filed: Feb. 5, 2009

Related U.S. Application Data
(60) Provisional application No. 61/026,834, filed on Feb. 7, 2008.

(51) Int. Cl. H04M 15/06

(52) U.S. Cl. 379/142.08

(57) ABSTRACT

The disclosed system and methods enable meticulous communication between two parties initiated by an unanswered telephone call. Particularly, complex actions may be taken based on a called telephone number and calling line identification (CLI). A selected action may be any action performable by a computer, and may include multiple actions or be a sub-part of a chain of actions. Thus disclosed is a dynamic, buildable communication system to end users.

### CROSS-REFERENCE TO RELATED APPLICATIONS

This utility patent application claims priority from U.S. provisional patent application Ser. No. 61/026,834, filed Feb. 7, 2008, titled “Present invention is a communication system that allows for the successful transmission and reception of meticulous communication—from an unambiguous sending party to an intended receiving party—and the consequences of the communication and its additional customizable interpretations to be then further used for multifarious actions, publishing, and consequent retrieval and manipulation, ad nauseam ad infinitum” in the name of Mamoon Tariq Khan.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2009 Mamoon Tariq Khan.

### BACKGROUND

1. Field of Disclosure

The present invention relates generally to the field of communication, and more specifically to handling of telephone calls.

Typically, communication systems have basically been comprised of: 1) oral messages or written letters carried by personal delivery; 2) letters delivered through a formal mail system such as a governmental postal system; 3) messages transmitted through a telegraph system; 4) conversations through wired telephones; 5) text through facsimile machines; 6) conversations through wireless/mobile/cellular telephones; 7) text or electronic mail through the internet; 8) text through the short message system of wireless/mobile/cellular phones.

One particular problem with conventional communication systems is the time, effort, money, and other resources required, particularly when a short yet precise message has to be communicated. Another problem with most conventional communication systems is that they require a minimum level of literacy and technical and physical dexterity. A further problem is the variable cost involved with almost every communication made over and above the fixed costs of acquiring equipment and a service subscription. An additional problem is the absence of communication devices or required services available in all geographic areas to every person.

2. Description of Prior Art

Caller line identification, or CLI, is an old technology related to telephones. Standard usage involves displaying the CLI so someone can recognize who is making a phone call. In certain circumstances, such as 911 emergency calls, CLI is used to identify a location to dispatch services. Simple actions such as missed call alerts may forward CLI information based on a call being missed. Similarly, call blocking services may automatically reject incoming calls based on CLI without letting them ring. Alternatively to blocking, call routing may direct different calls to different destinations based on CLI. Based on such routing and identification, custom messages may be played after answering the call, or played as a ring back tone while the call is ringing. Call reversal is another current use of CLI in trigger call-back systems, where the calling party hangs up after hearing an initial ring. Based on CLI information, a second call is made from the called location back to the caller, thereby reversing the call and shifting who incurs charges for the call. Such set of CLI uses as currently known involve simple actions—identification, notification, forwarding, rejecting, ring back tone playing, and reversing—based on the calling information.

In the patent application for a “Method for simplified one-touch ordering of goods and services from a wired or wireless phone or terminal,” US 2002/0049644, CLI information is used to recognize callers who have “enabled one-touch ordering” to help rapid repeat or new order placement based on a transmitted transaction code from the caller which is decoded after a call is received.

### BRIEF SUMMARY

The disclosed system and methods enable meticulous communication between two parties initiated by an unanswered telephone call. Particularly, complex automated actions may be taken based on a called telephone number and calling line identification (CLI). The action taken may be from a set of two or more actions. The set of actions may be a fixed set, a customized set identified by CLI, or a hybrid set of fixed and customized actions. The called telephone number may uniquely select one action from the set, may select one action by sending dual-tone multi-frequency (DTMF) tones, or may select one action uniquely in conjunction with countable criteria within the incoming call, such as seconds of duration, number of rings, position during a ring back tone, or DTMF signals transmitted before call termination. Termination of the call may be made by the called party without answering the call. A selected action may be any action performable by a computer, and therefore may activate programs including multiple actions. A selected action may also be a sub-part of a chain of actions, each selected in the same manner of identification by called telephone number and CLI. Confirmation may be provided by telephone or electronic return communication, and security may be added through confirmation or through other requirements.

An additional embodiment presents, instead of a plurality of action choices, a single telephone number which may disconnect an incoming call and return a configurable electronic message to the calling number. Such message may be configured to include information such as, but not limited to, current status, current contact details, hours of operation, upcoming events, available products and services, available choices, advertisements, or any other desired information.

### Features and Advantages

The disclosed system and method has many features and advantages. For users, a great benefit is a costless, universal system. Because actions are ordered based on a called telephone number and the CLI, they may be taken without accepting or answering the incoming call. In this fashion phone charges are avoided by the calling party. As calls do not incur charges, long distance considerations are not a factor. Thus service providers may operate any number in any area code in any country to provide actions on demand without cost, as the calls need not be completed. Further, requirements for access are limited to having a telephone. In doing so, computer controlled resources and actions may be accessed, at no direct cost, by users with or without a computer or internet access.

### BRIEF DESCRIPTION OF THE DRAWINGS

In the drawings, closely related figures and items have the same number but different alphabetic suffixes. Processes, states, statuses, and databases are named for their respective functions.

FIG. 1 shows an example Moonitin system for placing and handling orders.

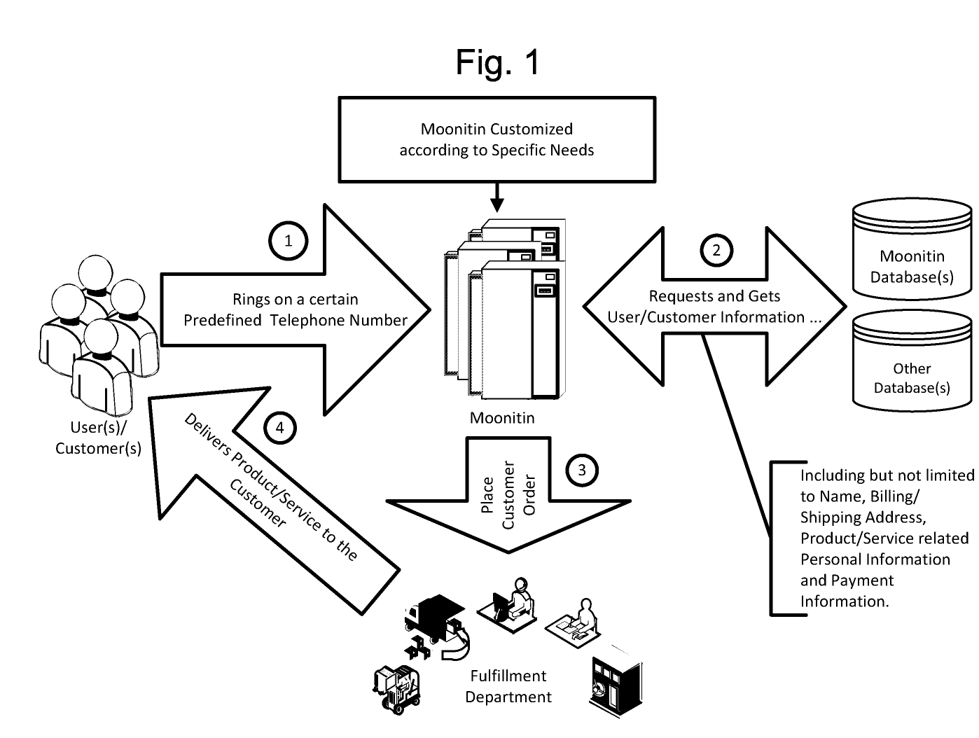

FIG. 2 shows an example Moonitin system for associating actions with dialed numbers.

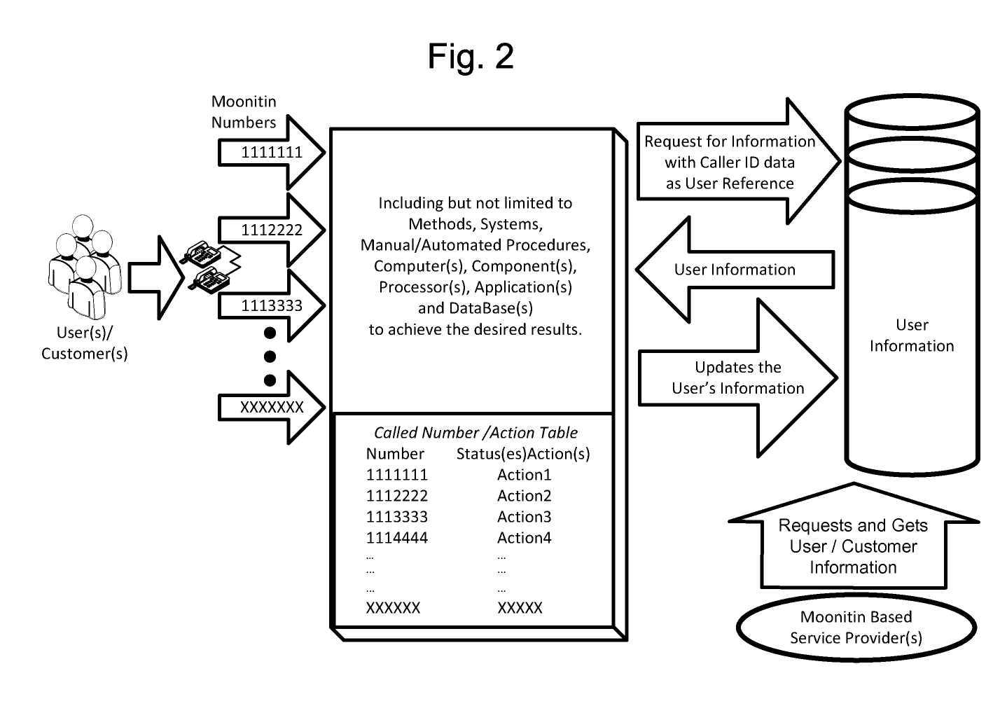

FIG. 3 is a flowchart showing various options for updating user information accessed by Moonitin systems.

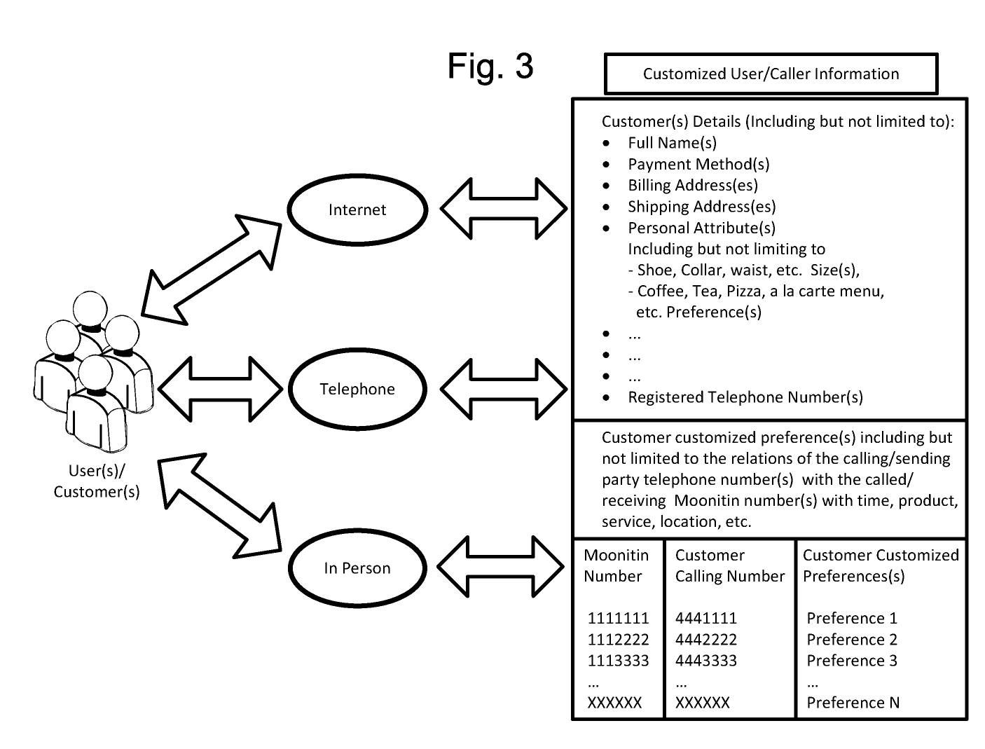

FIG. 4 is a flowchart showing the process of verifying and requesting needed information to process an action selected by Moonitin.

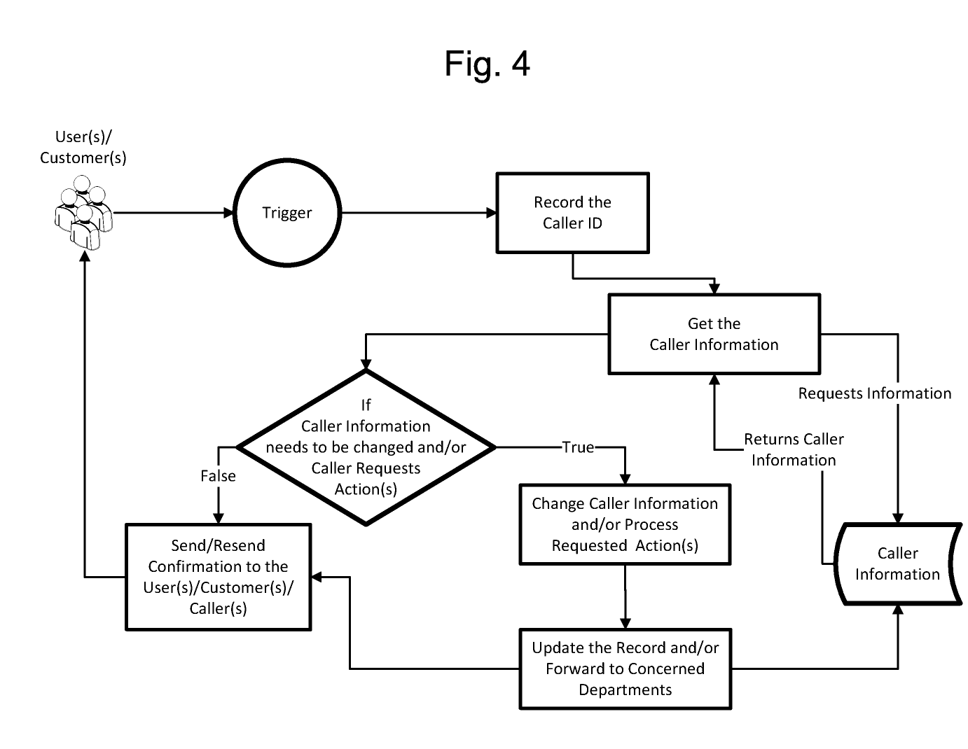

FIG. 5 is a flowchart showing a multi-Moonitin action selection process.

FIG. 6 is a flowchart showing a single Moonitin electronic message response process.

### DETAILED DESCRIPTION

In the following detailed description, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

### Terminology

The terminology and definitions of the prior art are not necessarily consistent with the terminology and definitions of the current invention. Where there is a conflict, the following definitions apply.

simple actions: identification, notification, forwarding, rejecting, playing ring back tone, and reversing based on CLI

complex actions: any action based on combination of dialed number identification choice and CLI

Moonitin: a Moonitin is an identification made by dialing one out of a set of numbers grouped together and each presenting a unique action choice, by dialing a single number and sending DTMF tones to identify a unique action choice, or by dialing a single number and making a choice by hanging up after a discrete number of seconds, rings, position during a ring back tone, or DTMF signals, wherein a different number would identify a different choice.

Telephonic trigger: a single number dialed among a set of numbers, or DTMF signals sent during the ringing of a phone call, or countable criteria such as number of rings, number of seconds, position during a ring back tone, or DTMF signals prior to disconnecting a ringing phone call.

### Operation

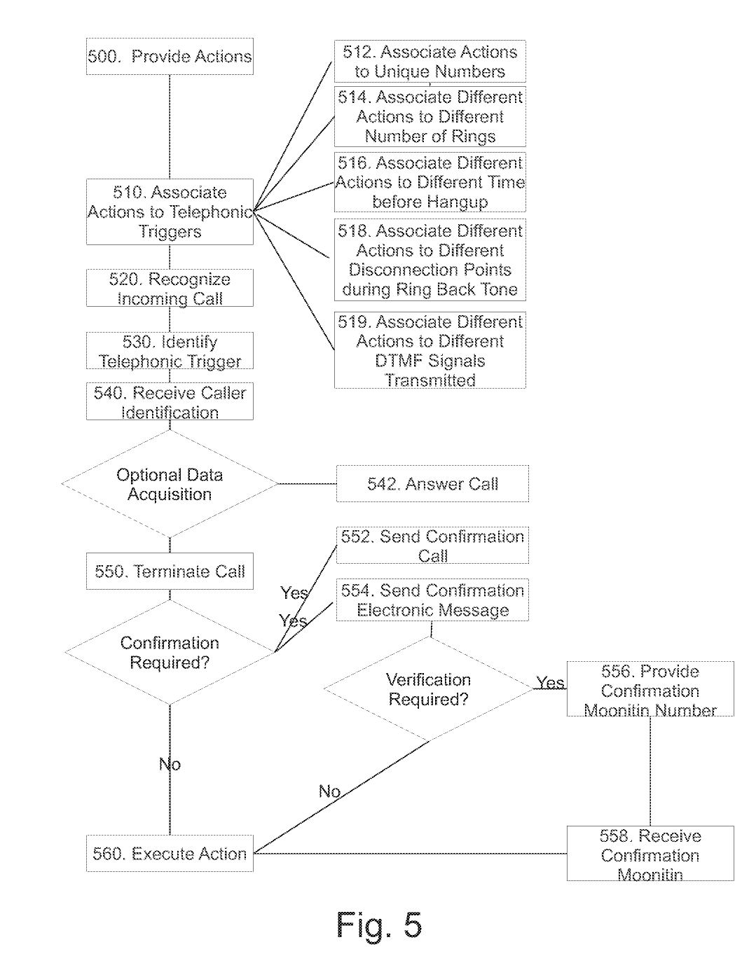

Referring to FIG. 5, in one embodiment, a system includes a telephone call control device and a computer program which may take one of various actions 500. The call control device may receive a single line input, or be connected to respond to calls on multiple telephone lines. Upon recognizing 520 an incoming call, the call control device may identify the called number associated with the incoming call. In addition, the telephone call control device may also receive 540 caller identification information. Such identification information may include, but is not limited to, incoming telephone number, caller name, geographic location, global-positions system (GPS) data, international mobile equipment identity (IMEI), cell tower identification data, biometric data, or other information associated with the calling party. Upon obtaining such caller identification information, the call control device may terminate 550 the call without answering the call. This termination without answering saves charges from being assigned under most telephone service plans. Termination may be done by disconnecting the incoming line, switching to a busy status, or other appropriate means. In addition to terminating the incoming call, the call control device may pass the caller identification information along with identification of which phone number was called to a software program which may execute 560 a desired action.

The action executed may be any action executable by a computer program. For example, one implementation may include a call control device responsive to two telephone numbers. Two opposing predefined values could be set depending on which number was called. Examples of values include, but are not limited to, “Available” or “Unavailable,” “Open” or “Closed,” “Coming” or “Going,” or “On Duty” or “Off Duty.” Upon receipt of the information from the call control device, the software action could set the status matching the dialed telephone number to the caller identified by the caller identification information. The software may further look up any additional information associated with the user, such as, but not limited to, a destination email address list, social networking site access, or other action destination information, and provide the status to such destinations. In this fashion, sending communications made available through such a system is only as time consuming as dialing a number—or a speed dial button or voice recognition dialing already mapped to the appropriate number.

The number of actions controllable in such fashion may be modified by increasing the number of phone lines associated 512 to actions, or by increasing control over the signaling message in placing the call. In a simple one-to-one phone line to action arrangement, a single choice of action could be configured based on response to a single number called from a set of two numbers, while a choice of one hundred actions could be configured based on which one of a hundred phone lines was called. The only limitation in such embodiment is the number of lines connected. In alternative embodiments, the call control device may be configured to have increased control over a single call. For example, the call control device may recognize DTMF signals transmitted 519 with the incoming call while it is still in a ringing state, and take action based on the DTMF signals. Additionally, the call control device may transmit DTMF signals while in a ringing state, allowing the calling device to signal an action based on additional action such as hanging up to terminate the call. In an alternate embodiment, the call control devices may increase a count until the calling party hangs up or a maximum count is reached, at which point the call control device may terminate the call. The count may be associated with different actions, and may be based on various criteria such as as number of seconds 516, number of rings 514, or other discrete criteria desired in the embodiment. For example, disconnection instructions to indicate different options may be played or encoded at various points 518 in a customized ring back tone played instead of standard ringing. In such a configuration, the number of available actions becomes the product of the maximum count allowed and the phone lines available. For example, associating ten different actions may be accomplished by a single line and call control device counting up to ten rings, or alternatively accomplished by two lines counting up to five rings, or into ten separate lines without any count implementation. The identification of each distinct action, corresponding to a separate line or counted trigger on a multi-action line, is a Moonitin. Thus the software may associate an action based on CLI with each available number or other identified telephonic trigger 510.

The distinct actions associated with Moonitins may be preset programmatically, stored in an alterable medium such as a database, or a combination of both. For example, an implementation to provide updated statuses to a social networking site could provide ten Moonitins. All ten could be preset status messages, such as “Asleep,” “Awake,” “Traveling,” etc., such that any calling the associated Moonitin would update that status for the caller identified by CLI. Thus, every caller would have the same ten status choices. Alternatively, users may access an interface, such as, but not limited to, a web page, short messaging system (SMS), interactive voice response system (IVR), or directly through customer service, and set customized status messages for each Moonitin. Thus, a caller identified by CLI would get the customized status if set for the associated Moonitin. In a mixed implementation, some of the Moonitin actions may be customizable, while other may remain fixed. For example, “Asleep” and “Awake” statuses could be fixed for all users, while customizable actions could be available for the remaining actions.

Actions may be individual value updates, such as setting a status, or alternative programmatic actions including sets of actions. For example, an action may be configured to send multiple emails, faxes, or text messages when selected by Moonitin. Sales may be accomplished by Moonitin, as CLI may identify the calling party as placing an order. For example, a restaurant may associate ten Moonitins with orders for ten different types of meals. A received Moonitin would associate an order for the appropriate type of meal with the party identified by CLI. By allowing customizable Moonitins, a fast food parlor may allow users to pre-configure specific meals to be ordered different from default options, allow configuration of delivery locations, pickup options, different payment options, or any other customization desired.

Actions may be further enhanced by allowing nested actions. For example, a restaurant may provide Moonitins for each of the different available condiments, Moonitins for any available meal sizes, other available options, and then ‘begin,’ and ‘order.’ In this embodiment, a user may dial the Moonitin to begin, follow that by dialing each desired condiment, the desired size, and then the order option. As an alternative to requiring the order Moonitin, a periodic time-out could automatically complete and process the order. Alternative to requiring the being Moonitin, any initial Moonitin making an order selection may begin the process of a nested Moonitin until the order or time-out condition is reached. Thus, a chain of Moonitin actions may be nested to build a complex order, linked by calling CLI. Such an embodiment is not limited to ordering. For example, dynamic text building could be enabled by providing Moonitins for alphanumeric characters. Thus a message could be built by dialing each desired character, or operating a program on a calling device to queue and automatically dial all desired characters. Such text may then be sent by Moonitin specifying delivery actions, such as, but not limited to, SMS, email, fax, or status updating. Throughout this disclosure, all discussion of Moonitin actions may also be accomplished by use of nested Moonitins.

Some actions, such as ordering an item, may require additional information, such as payment information, to process the action. Such additional information may be stored as user information in a database or other storage medium and associated or accessed by identifying data included in the CLI. Should an action be selected by Moonitin, yet insufficient information exist associated with the CLI to complete the action, sufficient information, such as calling number or an electronic identifier, in the CLI may allow a phone or electronic contact to the originating caller to obtain required additional information to perform the action. For example, a retailer may process orders based on Moonitins using payment information stored and associated with specific CLIs. The retailer may lack such payment information for new customers, thus on receipt of a new order a call or electronic message requesting payment information may be sent. Upon receipt of such payment information, it may then be associated with the CLI for future orders. Additionally, should multiple information choices such as multiple payment options be linked to the same CLI, selection may be made by an additional Moonitin which may be preconfigured or provided to the caller by message after the initial Moonitin.

In some situations secure confirmation may be desired before performing an action. There exist multiple different means and levels of security. One such implementation may be to process orders or deliveries only to fixed lines associated with permanent addresses. Alternatively, secure phones, such as those requiring biometric or other secure measure to access, may be required to trigger secure Moonitin actions. Other security methods may be implemented through confirmations. A basic confirmation may be done by sending a phone call 552 or electronic message 554 to the originator caller, or a configured confirmation address associated with the CLI, after receiving a Moonitin. Phones may be configured to do-not-answer status for expected confirmation lines, such that a placed Moonitin action may generate a callback confirmation which also would not be answered, as seeing the calling CLI may be sufficient confirmation. Alternatively or in addition to the above confirmation, use of ring back tones may be used to play a confirmation message to a Moonitin without actually answering the phone. Such a ring back tone may also be configured to list options for telephonic triggers such as disconnecting at a particular time, or include DTMF signaling that may be processed and returned by the calling device enabled to understand and produce such signals. To add security beyond confirmation, a second Moonitin may be required. The confirmation message sent may provide 556 the second Moonitin which may then be called and received 558 to confirm, approve and complete the initial Moonitin action. In addition, a Moonitin may be answered 542 instead of disconnecting to confirm an order or obtain additional information. As such action connects the call, it may incur charges to the calling party.

Dialing Moonitins may be done by manually entering a number or by selecting auto-dial options saved in phones or other calling devices. As different services and providers may have many Moonitins, directory applications such as contact databases may be desirable, customizable, and navigable by the provider or service. Some phone numbers may be memorable by pneumonic devices, while others may change the actions over time and be desirable for frequent updating. Updates to Moonitin listings may be done by applications on a calling device, such as received SMS messages or downloaded data listing updates, or scanned input such as photographed barcodes encoding Moonitin listings and information. Updates could be set to automatic or manually triggered such as a Moonitin configured to provide updated listings. Geographic location information, such as, but not limited to, GPS, cell tower, area code prefixes, or other locating technology, also may be configured. For example, a Moonitin action may be enabled to update Moonitin listings for all restaurants within a five-mile radius of the current location. Calling that Moonitin, in connection with CLI and geographic location data of the originating call, may transmit to the caller through a voice call, SMS, fax, email, or other electronic message, updated Moonitins from a directory listing such Moonitins by location. Such an example may apply to any other criteria for requests or geographic region desired.

In addition to geographic range availabilities, other location based Moonitin information may be provided. For example, Moonitin listings for cities, shopping malls, department stores, or other entities may be available. Access may be manually requested, distributed by display or advertisement, or made automatically available based on geographic information. GPS data, cell tower location, Bluetooth, Wi-Fi, or other location aware or location based technology may enable automatic receipt, lookup in an internal listing, or request and receipt of such for Moonitin area listings. Upon dialing of such a Moonitin, which may be done manually or automatically, location information may be retained about the caller. Such location information may be used for targeted, timely advertisements, or to interact with time and location relevant data. For example, one of the Moonitins provided in a location-specific department store Moonitin listing may be to trigger download or purchase of music currently playing in that department store. Such action may be further localized to precise location-specific operation such as requesting product information based on a nearby display, or expanded to any other action appropriate to location aware customization.

A further consideration includes use of telephones, such as public phones, organizational phones, or the individual phone of a person other than the caller, to provide valid CLI information. In such a scenario, the dialing phone may be properly identified, but the actual caller may be unknown or incorrectly identified. To address such concerns, a universal service may be provided to temporarily set alternative identification information for a given CLI. A personalized Moonitin may be provided, such that calling the personalized Moonitin will set the identification information associated with the calling line to the information associated with the actual caller. Such association may be maintained for a set time, a set number of calls, until a terminating Moonitin is dialed, or until some other terminating criteria is signaled. An entity receiving a Moonitin call may verify the CLI information with the universal service, through Internet or direct connection means, to receive current personalized identification associated with the CLI. Security measures, including those discussed previously, may be implemented along with such a service.

### OTHER EMBODIMENTS

An example implementation may be for use selling advertised products. Printed, electronic, broadcast, or other advertisements could contain listing of featured goods and associated Moonitin. Ordering would involve calling the appropriate number, which may then associate the order based on the identified good and CLI. Optional confirmation may be made as detailed above. Customized advertisements could be dynamically created based on individual users, such as targeted marketing or advertisements based on tracked user status, with updates to Moonitin actions to match the customized advertisement based on CLI. In addition to direct ordering, Moonitin actions could trigger delivery of more information, such as product details, multimedia files, or applications via SMS or other electronic delivery on call. Further Moonitin ordering information may be included with such delivered additional products.

An example implementation may be for a company to use Moonitins for employee tracking. Every employee may dial a Moonitin on arriving, and another on leaving, like punching a time clock. Additional Moonitins may be set up and configured to associate with other employee statuses, such as in a meeting, or tied to activity on specific projects.

An example implementation may be for a cab company which has strategically chosen Moonitin numbers that begin with the same five numbers but end with various two digit numbers. The two digit numbers may correspond with the number of minutes or hours after which the caller, identified by CLI, would like a cab. This may be extended to any other example implementation using any number of Moonitin numbers to identify various time signaling as part of the action.

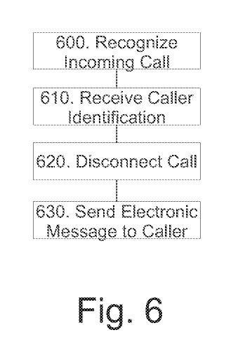

Referring to FIG. 6, an alternative embodiment presents, instead of a plurality of action choices, a single telephone number which may disconnect 620 a recognized 600 incoming call after receiving 610 CLI information and send 630 a configurable electronic message to the originating number. Such message may be sent without any attempt or action to ring or connect the incoming call to a human recipient or voice mailbox. Thus a single point for requesting electronic message information may be provided for any individual or other entity. For example, such a number may be configured by a retail store to respond by SMS with daily specials or hours of operation or advertisements or any other information. Further, such responses may be controlled and configured based on CLI. For example, an individual may configure responses sent out from the dialing of their Moonitin to provide a current status message. Additional examples of the configured message may include direct contact details to all or a set of authorized callers identified by CLI, and other default information or no response at all to unauthorized callers. As another example, a hospital may provide a Moonitin number for a patient, configured to send current medical status to callers, such as a primary doctor or family members, approved by the patient.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system for automating actions based on telephone calls, comprising:
a telephone call control device, said device capable of
recognizing a telephonic trigger associated with an incoming telephone call;
receiving caller identification with said incoming telephone call; and
terminating said incoming telephone call; and
a computer readable medium containing instructions for:
receiving said caller identification and a dialed number of said incoming telephone call from said telephone call control device;
associating an action with said telephonic trigger and said caller identification; and
performing said action.

2. The system of claim 1, wherein terminating further comprises switching a state of said incoming telephone call from ringing to busy.

3. The system of claim 1, wherein said telephone call control device is further capable of identifying termination of said incoming telephone call wherein termination was performed by a calling party of said incoming telephone call.

4. The system of claim 3, wherein recognizing a telephonic triggers comprises counting a number of seconds between recognizing said incoming telephone call and identifying termination.

5. The system of claim 1, wherein recognizing a telephonic trigger comprises counting a number of rings of said incoming telephone call.

6. The system of claim 1, wherein said recognizing a telephonic trigger comprises identifying a dialed telephone number from a set of two or more available telephone line numbers.

7. The system of claim 1, wherein associating an action further comprises selecting a preset action based on said dialed number.

8. The system of claim 1, wherein associating an action further comprises selecting a customized action identified by said caller identification and said dialed number.

9. The system of claim 1, wherein said computer readable medium contains further instructions for accessing stored user information required to perform said action.

10. The system of claim 1, wherein said computer readable medium contains further instructions for contacting the originator of said incoming phone call to obtain information required to perform said action.

11. The system of claim 1, wherein said computer readable medium contains further instructions for contacting the originator of said incoming phone call to confirm said action.

12. The system of claim 1, wherein said telephone call control device is further capable of providing a ring back tone confirmation message while said incoming phone call is in a ringing state.

13. The system of claim 12, further comprising a telephone, said telephone capable of originating said incoming phone call, deciphering said ring back tone confirmation message, and terminating phone call based on messages included in said ring back tone confirmation message.

14. The system of claim 1, wherein said telephone call control device is further capable of recognizing dual-tone multi-frequency signals sent with said incoming telephone call while said incoming telephone call is in a ringing state.

15. The system of claim 1, wherein said telephone call control device is further capable of originating dual-tone multi-frequency signals sent with said incoming telephone call while said incoming telephone call is in a ringing state.

16. The system of claim 1, wherein said telephone call control device is further capable of receiving geographic data about a location of origin of said incoming telephone call.

17. A method of selecting an action to performing, comprising:
providing two or more actions;
associating each action to a telephonic trigger;
recognizing an incoming telephone call;
identifying an incoming telephonic trigger from said incoming telephone call;
receiving a caller identification with said incoming telephone call;
terminating said incoming telephone call; and
executing an action mapped to said incoming telephonic trigger for said caller identification.

18. The method of claim 17, wherein associating each action to a telephonic trigger further comprises associating each action to a unique telephone number.

19. The method of claim 17, wherein associating each action to a telephonic trigger further comprises associating each action to a different number of rings.

20. The method of claim 17, wherein associating each action to a telephonic trigger further comprises associating each action to a different number of seconds.

21. The method of claim 17, wherein associating each action to a telephonic trigger further comprises associating each action to a different disconnection point during ring back tone.

22. The method of claim 17, wherein associating each action to a telephonic trigger further comprises associating each action to dual-tone multi-frequency signals transmitted during ringing of said call.

23. The method of claim 17, further comprising sending a confirmation phone call to an originating caller identified by said caller identification.

24. The method of claim 17, further comprising sending an electronic message confirmation to a confirmation address associated with said caller identification.

25. The method of claim 24, further comprising:
providing a confirmation number in said electronic message confirmation;
receiving a second incoming call at said confirmation number;
approving the selected action.

26. The method of claim 17, further comprising answering said incoming phone call before disconnecting.

27. A method of responding to a telephone call, comprising:
recognizing an incoming telephone call;
receiving a caller identification from said incoming telephone call;
disconnecting said incoming telephone call; and
sending an electronic message to an originating number of said incoming telephone call.

28. A system for accepting electronic message requests, comprising:
a telephone call control device, said device capable of
recognizing an incoming telephone call on a single telephone line;
receiving caller identification with said incoming telephone call; and
terminating said incoming telephone call; and
a computer readable medium containing instructions for:
receiving a dialed number of said incoming telephone call from said telephone call control device; and
sending an electronic message to a originating number of said incoming telephone call.
